(19) United States
(12) Patent Application Publication
(10) Pub. No.: US 2014/0016339 A1
(43) Pub. Date: Jan. 16, 2014

(54) INTERIOR ILLUMINATING APPARATUS FOR VEHICLE

(71) Applicant: Shinji Mochizuki, Makinohara-shi (JP)

(72) Inventor: Shinji Mochizuki, Makinohara-shi (JP)

(73) Assignee: YAZAKI CORPORATION, Tokyo (JP)

(21) Appl. No.: 14/007,123

(22) PCT Filed: May 11, 2012
(86) PCT No.: PCT/JP2012/062735

§ 371 Date: Sep. 24, 2013

(30) Foreign Application Priority Data
May 12, 2011 (JP) 2011-107646

(51) Int. Cl. B60Q 3/02

(52) U.S. Cl. CPC B60Q 3/0203
USPC 362/490

(57) ABSTRACT

In the case of storing a bus bar in a housing, terminals for switch connection of the bus bar are arranged so as to be exposed to a port for switch of the housing, and terminals for roof harness connection of the bus bar are arranged so as to be exposed to a connector port for roof W/H connection of the housing, and crimp terminal parts of the bus bar are arranged so as to be exposed to the inside of an electric wire holder port of the housing, and engaging protrusions formed on a bus bar holder are engaged and fixed to engaging recesses formed in the housing.

### TECHNICAL FIELD

The present invention relates to an interior illuminating apparatus for vehicle mounted in a roof part etc. of a vehicle room, and particularly to a part called a functional part equipped with a functional component such as an LED or a switch.

### BACKGROUND ART

A roof part of an automobile is equipped with an interior illuminating apparatus and as one example of the apparatus, an apparatus described in PTL 1 is known. An object of this interior illuminating apparatus for vehicle is to surely prevent a switch mounted once from coming out while the switch can smoothly be assembled without trouble, and the interior illuminating apparatus is attached to, for example, a roof part of a vehicle room.

This interior illuminating apparatus for vehicle described in PTL 1 is constructed so that the periphery of a switch mounting part is provided with a guide wall 116 for guiding insertion from the inlet toward the back and a protective cover 140 is provided with an engaging protrusion for inhibiting removal by engaging with a protrusion 124 of the side of a body case 21 of a switch 120 and also is provided with a bulb press wall 147 for guiding insertion of a bulb 50.

That is, this interior illuminating apparatus includes a resin-made housing 10, a switch 20 for turning on and off a light, a bus bar 30 constructing a circuit, a resin-made protective cover 40, and the bulb (an electric lamp etc.) 50 which is a light source as shown in FIG. 9 of PTL 1.

As shown in FIG. 10 of PTL 1, this housing 10 has substantially a flat bottom plate 15 and the upper side of the bottom plate 15 can be equipped with components, and the housing 10 has a bulb mounting part 11 for mounting the bulb 50 obliquely from above in one end side and also has a switch mounting part 13 for mounting the switch 20 from a lateral part in the other end side and has a bus bar mounting part 12 between the bulb mounting part 11 and the switch mounting part 13.

Also, as shown in FIG. 9 of PTL 1, the bus bar 30 is mounted in the bus bar mounting part 12 of the housing 10 from above, and has an electrode 31 electrically connected to the bulb 50 mounted in the bulb mounting part 11 in one end side and also has a terminal 33 electrically connected to the switch 20 mounted in the switch mounting part 13 in the other end side and has an electric wire crimp part 32 for connecting an electric wire by crimping in the middle between the electrode 31 and the terminal 33.

Then, as shown in FIGS. 9 and 11(b) of PTL 1, the protective cover 40 is means for protecting the electric wire crimp part 32 of the bus bar 30, and is mounted and fixed to the housing 10 so as to cover the bus bar mounting part 12 after crimping of the electric wire and before mounting of the bulb 50. One end side and the other end side of this protective cover 40 are provided with extension walls 41, 43 projecting to the sides of the bulb mounting part 11 and the switch mounting part 13.

The switch 20 in this interior illuminating apparatus is a push switch of an alternate type (a type in which an ON/OFF state is switched alternately every time the switch is pushed once), and has the body case 21 in the lower portion and has a cylindrical part 22 on the body case 21 and has a push button 25 on the cylindrical part 22 as shown in FIG. 11(a) of PTL 1.

Further, the switch 20 in the interior illuminating apparatus is held by pinching a base part inserted into the bulb mounting part 11 of the housing 110 using the bulb press wall 147 of the protective cover 140 as a guide by a spring part of the electrode 31.

### CITATION LIST

### Patent Literature

[PTL 1] JP-A-2010-205617

### SUMMARY OF INVENTION

### Technical Problem

Such an interior illuminating apparatus for vehicle of a conventional example described in PTL 1 has a problem that only the bulb (an incandescent electric lamp) is attached as a light source and there is no flexibility.

Also, the interior illuminating apparatus for vehicle of the conventional example described in PTL 1 has a problem that positions of the switch 20 and the light source (bulb) 50 and a direction of the light source (bulb) 50 are fixed and there is no flexibility.

One object of the invention is to provide an interior illuminating apparatus for vehicle capable of easily fixing a bus bar to a housing.

Another object of the invention is to provide an interior illuminating apparatus for vehicle capable of being provided with flexibility even in the case of changing a direction of an LED which is a light source and forming electrical connection between the LED and a roof harness at low cost.

### Solution to Problem

An interior illuminating apparatus for vehicle according to a first aspect of the present invention, in which an LED unit into which an LED is incorporated is mounted in a housing and a bus bar holder to which a bus bar for electrically connecting the LED to a roof harness is fixed is assembled to the housing and the LED is turned on and the inside of a vehicle room is illuminated, and wherein the bus bar includes terminals for switch connection which are electrically connected to a switch and are formed on one end side of the bus bar, terminals for roof harness connection which are electrically connected to the roof harness wired to a roof of the inside of the vehicle room and receive supply of a power source, and crimp terminal parts for connecting an electric wire by crimping in the middle between the terminals for switch connection and the terminals for roof harness connection, and in the case of storing the bus bar 23 in the housing, the terminals for switch connection of the bus bar are arranged so as to be exposed to a port for switch of the housing, and the terminals for roof harness connection of the bus bar are arranged so as to be exposed to a connector port for roof W/H connection of the housing, and the crimp terminal parts of the bus bar are arranged so as to be exposed to the inside of an electric wire holder port of the housing, and engaging protrusions formed on the bus bar holder are engaged and fixed to engaging recesses formed in the housing.

According to the first aspect of the present invention having such a characteristic feature, the bus bar can easily be fixed.

In an interior illuminating apparatus for vehicle according to a second aspect of the invention, electrical connection between the LED and a roof harness made by assembling the bus bar holder to which the bus bar is fixed to the housing is made so that using a splicer constructed of an electric wire and electric wire holders attached to both ends of the electric wire, one electric wire holder is electrically connected to the LED unit and also the other electric wire holder is inserted into the electric wire holder port of the housing and crimp connection is made by crimp terminal parts of the bus bar exposed to the inside of the electric wire holder port.

According to the second aspect of the present invention, connection between the LED unit and the housing is made by the electric wire of the splicer using the splicer for connecting the electric wire holder to both ends of the electric wire, so that the interior illuminating apparatus can be provided with flexibility even in the case of changing a position of the LED which is a light source.

Also, according to the second aspect of the present invention, electrical connection between the LED and the roof harness is not made directly and the electrical connection is made using the splicer for connecting the electric wire holders to both ends of the electric wire so that the electrical connection can be formed at low cost.

### Advantageous Effects of Invention

According to the invention, the bus bar can easily be fixed to the housing. Also, according to the invention, even in the case of changing the position of the LED which is the light source, the interior illuminating apparatus can be provided with flexibility, and electrical connection between the LED and the roof harness can be formed at low cost.

### BRIEF DESCRIPTION OF THE DRAWINGS

FIG. 1 is the whole perspective view showing an embodiment of an interior illuminating apparatus for vehicle according to the invention.

FIG. 2 is the whole perspective view at the time when the interior illuminating apparatus for vehicle shown in FIG. 1 is viewed from the inside of a vehicle room.

FIG. 3 is an exploded perspective view of an LED lamp subassembly of the interior illuminating apparatus for vehicle shown in FIG. 1.

FIG. 4 is an exploded perspective view of a housing subassembly of the LED lamp subassembly shown in FIG. 3.

FIG. 5 is a view showing a state of mounting a bus bar in a bus holder shown in FIG. 4.

FIG. 6 is a view showing a state of mounting the bus holder in which the bus bar is mounted in a housing shown in FIG. 4.

FIG. 7(A) is a plan view of the housing subassembly in a state of mounting the bus holder in which the bus bar is mounted in the housing shown in FIG. 4.

FIG. 7(B) is a sectional view taken on line A-A of the housing subassembly shown in FIG. 7(A).

FIG. 8 is an enlarged view of a place shown by P of FIG. 7(B).

FIG. 9 is a view showing mounting of an LED unit subassembly and mounting of a splicer for connecting the LED unit subassembly to the LED lamp subassembly of the interior illuminating apparatus for vehicle shown in FIG. 1.

FIG. 10 is a view describing an electric wire holder shown in FIG. 9.

FIG. 11 is an exploded perspective view showing a configuration of an LED unit incorporated into the interior illuminating apparatus for vehicle shown in FIG. 1.

### DESCRIPTION OF EMBODIMENTS

A preferred embodiment of a connecting structure of electronic components and a connecting unit of the electronic components according to the invention will hereinafter be described in detail with reference to the drawings.

The invention is constructed so that a bus bar having a terminal for switch connection, a terminal for roof harness connection, a crimp terminal part for making connection to a lamp for interior illumination and a fixing part to a bus bar holder is assembled to a housing of an interior illuminating lamp and the terminal for switch connection is positioned in switch attachment space of the housing and the terminal for roof harness connection is positioned in a connector port for roof W/H connection of the housing and also the crimp terminal part for making connection to the lamp for interior illumination is positioned in an electric wire holder port of the housing and a switch is assembled to the housing and thereby the terminal for switch connection is connected and fixed to a terminal part of the switch.

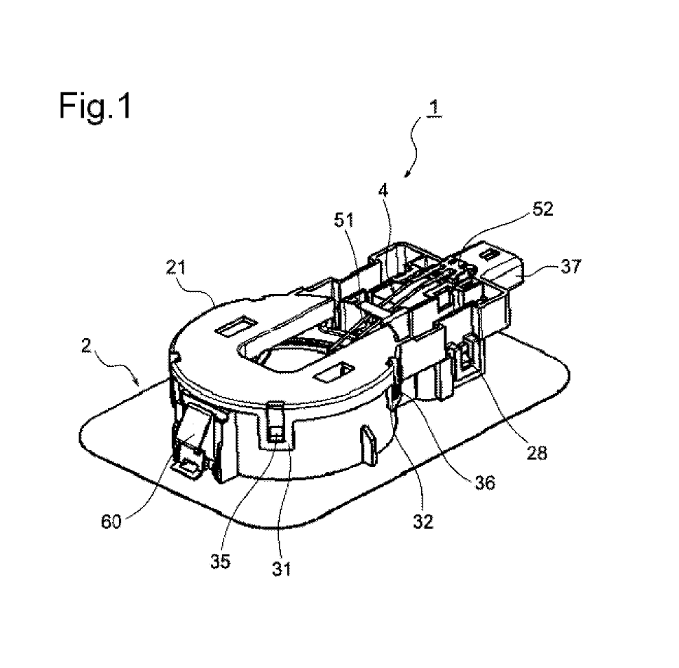

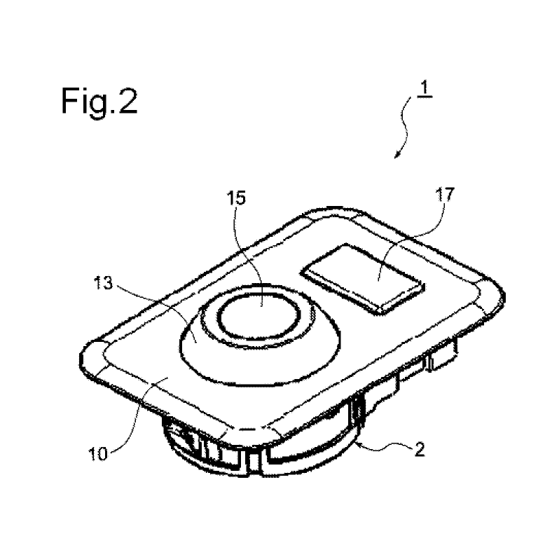

FIGS. 1 and 2 show an embodiment of an interior illuminating apparatus for vehicle, and FIG. 1 is the whole perspective view of the interior illuminating apparatus for vehicle, and FIG. 2 is the whole perspective view at the time when the interior illuminating apparatus for vehicle shown in FIG. 1 is viewed from the inside of a vehicle room.

In FIGS. 1 and 2, an interior illuminating apparatus 1 for vehicle has an LED lamp subassembly 2 for incorporating an LED as a light source of interior illumination for vehicle, an LED unit 100, and a splicer 4 for connecting the LED lamp subassembly 2 to the LED unit 100.

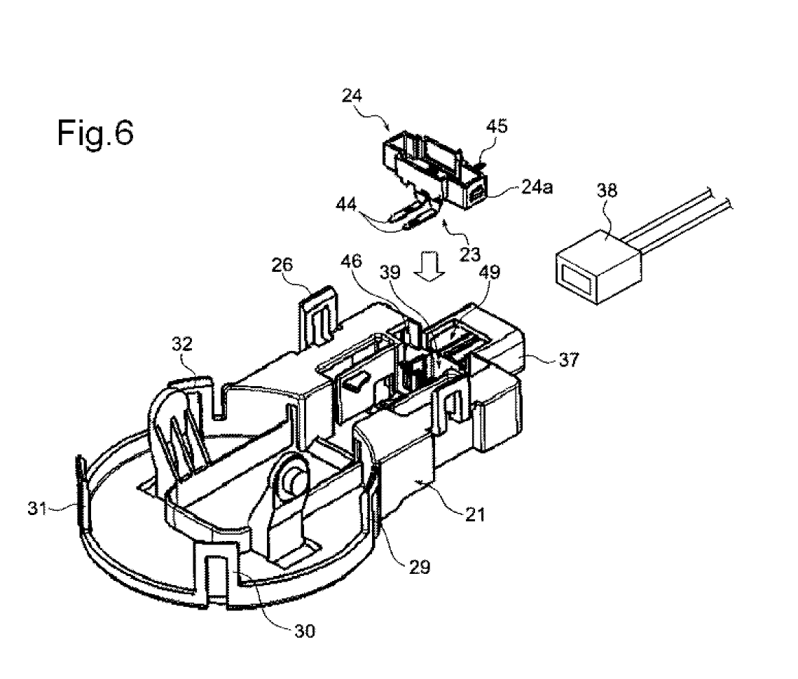

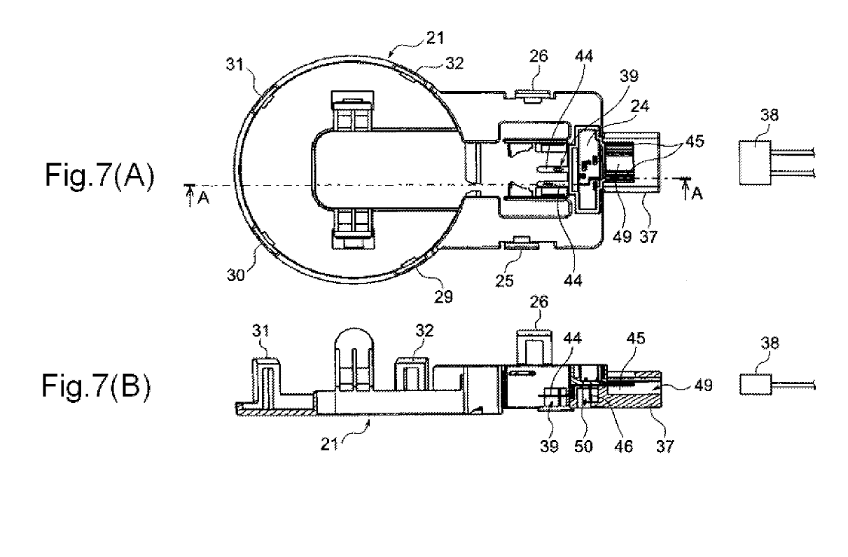

The LED lamp subassembly 2 is an illuminating device incorporated into a roof of the inside of the vehicle room as the light source of interior illumination for vehicle. A connector port 49 for roof W/H connection for mounting a connector 38 (FIGS. 6 and 7) to which a harness is connected is formed in this LED lamp subassembly 2 in order to connect a roof harness.

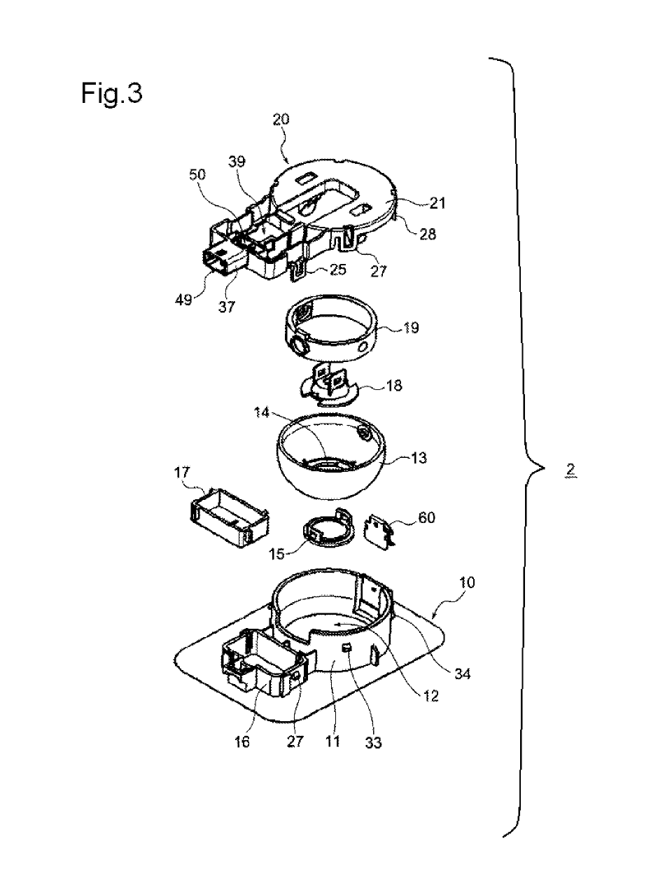

FIG. 3 shows the whole LED lamp subassembly 2.

In the drawing, the LED lamp subassembly 2 has a bezel 10 for roof formed in a plate shape and incorporated into the roof of the inside of the vehicle room.

This bezel 10 for roof is provided with a ring member 11 formed in a flange shape. Then, in the bezel 10 for roof, a through hole 12 is formed according to the ring member 11 and it is constructed so that a bezel 13 for illumination formed in a bowl shape is mounted in this through hole 12.

The bezel 13 for illumination has action of changing a direction of light of the light source (LED) mounted. The bottom of the center of this bezel 13 for illumination is provided with a hole 14, and a design lens 15 is mounted in this hole 14.

Also, in the bezel 10 for roof, a switch knob mounting part 16 is formed adjacently to the ring member 11, and a switch knob 17 is mounted in this switch knob mounting part 16. Then, a switch 22 described below is mounted in the switch knob 17.

Also, an LED unit holder 18 for holding the LED unit 100 is attached to the design lens 15 mounted in the bezel 13 for illumination. The inside of the vehicle room is irradiated with light emitted by an LED 107 of the LED unit 100 held by this LED unit holder 18 through the design lens 15.

The LED lamp subassembly 2 has a ring-shaped guide member 19 in order to fix a state mounted in the through hole 12 of the bezel 10 for roof without trouble after the bezel 13 for illumination is mounted in the ring member 11. This guide member 19 is mounted inside the ring member 11 and fixes the bezel 10 for roof.

Further, the LED lamp subassembly 2 has a housing subassembly 20 mounted so as to cover the ring member 11 and the switch knob mounting part 16 of the bezel 10 for roof from the upper side of FIG. 3.

In the drawing, numeral 60 is a clip, and the clip is means for retaining a flange 21 of the housing subassembly 20 in the ring member 11 by being mounted in the ring member 11.

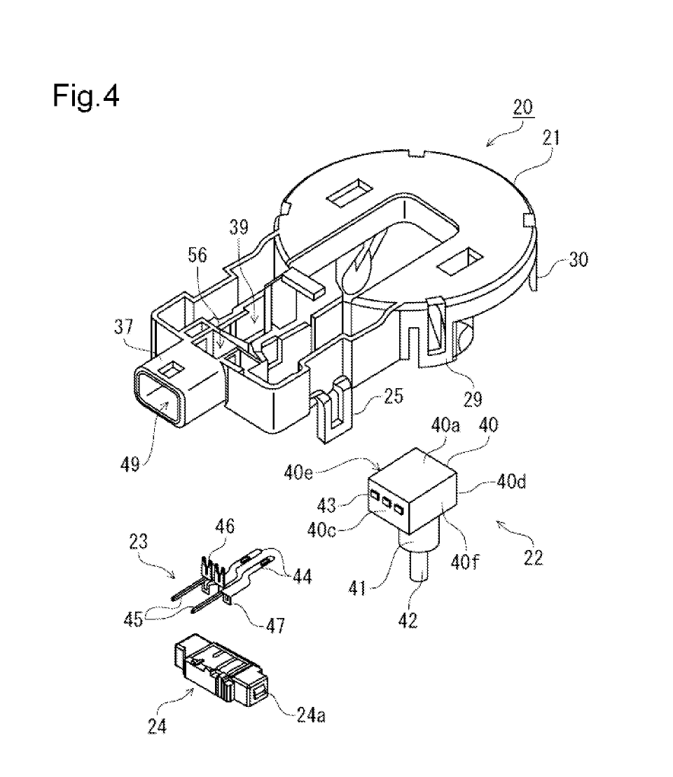

FIG. 4 shows the whole housing subassembly 20.

In the drawing, the housing subassembly 20 has a housing 21, the switch 22, a bus bar 23 and a bus bar holder 24.

After the switch 22, the bus bar 23 and the bus bar holder 24 are mounted, the bezel 13 for illumination in which the design lens 15 shown in FIG. 4 is mounted is attached and the guide member 19 is mounted in the upper edge of this bezel 13 for illumination and thereafter, the housing 21 is mounted in the ring member 11 formed on the bezel 10 for roof shown in FIG. 4 so as to cover the ring member 11 from above.

The housing 21 is provided with a pair of right and left engaging members 25, 26 in the side of covering the switch knob mounting part 16 of the bezel 10 for roof, and the engaging members 25, 26 engage with engaging protrusions 27, 28 formed on the switch knob mounting part 16 of the bezel 10 for roof and are fixed to the bezel 10 for roof.

Also, the housing 21 is provided with engaging members 29, 30, 31, 32 in the side of covering the ring member 11 of the bezel 10 for roof, and the engaging members 29, 30, 31, 32 engage with engaging protrusions 33, 34, 35, 36 formed on an outer peripheral surface of the ring member 11 of the bezel 10 for roof and are fixed to the bezel 10 for roof.

Also, the distal end of the housing 21 in the side of covering the switch knob mounting part 16 is provided with a roof harness connector connecting part 37. A roof harness connector 38 shown in FIG. 6 is mounted in this roof harness connector connecting part 37.

The side near to the ring member 11 in the roof harness connector connecting part 37 of this housing 21 is provided with a port 39 for switch for attaching the switch 22. The switch 22 can be mounted in this port 39 for switch from the lower side.

The switch 22 is constructed of, for example, a push switch of an alternate type in which an ON/OFF state is switched alternately every time the switch is pushed once. Then, this switch 22 has a body case 40 in the upper portion and has a cylindrical part 41 under the body case 40 and has a push button 42 under the cylindrical part 41. The body case 40 has a box shape of a rectangular parallelepiped having an upper wall 40a, a lower wall 40b, a front wall 40c, a back wall 40d, and right and left side walls 40e, 40f.

Also, the front wall 40c of the switch 22 is provided with terminal insertion holes 43 into which terminals 44 for switch connection, which are male terminals of the bus bar 23, are inserted.

One end side of the bus bar 23 has the terminals 44 for switch connection electrically connected to the switch 22 by being inserted into the terminal insertion holes 43 formed in the front wall 40c of the switch 22 mounted in the switch port 39.

Also, the other end side of the bus bar 23 is provided with terminals 45 for roof harness connection which receive supply of a power source and are electrically connected to terminals of the connector 38 to which a wire harness wired to the roof of the inside of the vehicle room is connected.

Further, in the bus bar 23, the middle between the terminals 44 for switch connection and the terminals 45 for roof harness connection is provided with crimp terminal parts 46 for connecting an electric wire by crimping. This crimp terminal part 46 is means for connecting an electric wire for supplying a power source supplied from the wire harness wired to the back of the roof of the inside of the vehicle room from a battery to a lamp for interior illumination by crimping.

Then, a lower surface of the bus bar 23 is provided with fixing parts 47 for fixing the bus bar 23 to the bus bar holder 24.

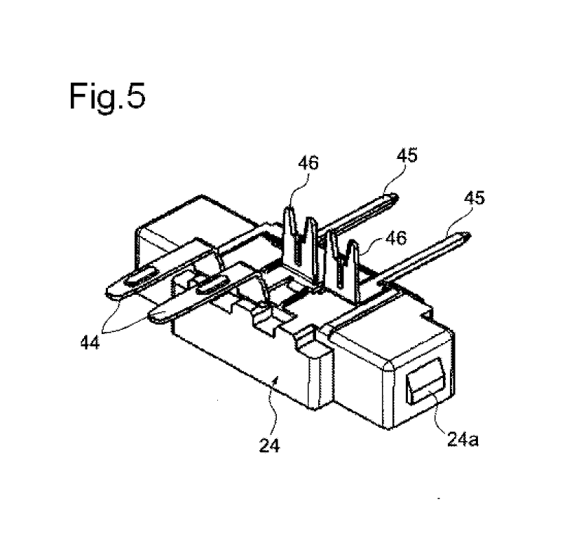

FIG. 5 shows the bus bar holder 24 in which the bus bar 23 is mounted.

In the drawing, the bus bar 23 is mounted by being fixed to the bus bar holder 24 with the fixing parts 47 and is held by the bus bar holder 24 formed in a rectangular parallelepiped.

The terminals 44 for switch connection electrically connected to the switch 22 by being inserted into the terminal insertion holes 43 formed in the front wall 40c of the switch 22 mounted in the switch port 39 project in one direction orthogonal to a longitudinal direction of the bus bar holder 24, and the terminals 44 for roof harness connection which receive supply of the power source and are connected to the wire harness wired to the roof of the inside of the vehicle room project in the other direction.

Further, the crimp terminal parts 46 for connecting the electric wire by crimping and making connection to the lamp for interior illumination project in an upper direction orthogonal to the projection directions of the terminals 44 for switch connection and the terminals 44 for roof harness connection in the bus bar holder 24.

Then, the longitudinal direction of the bus bar holder 24 is provided with engaging protrusions 24a on both side surfaces.

FIG. 6 shows the upper surface side (lower surface side shown in FIG. 4) of the housing 21 shown in FIG. 4.

In the drawing, the bus bar holder 24 to which the bus bar 23 is attached is mounted in the housing 21 so that the bus bar holder 24 in which the bus bar 23 shown in FIG. 5 is mounted is vertically inverted and the crimp terminal parts 46 are turned to the lower side (the crimp terminal parts 46 project downward in a state shown in FIG. 4).

This bus bar holder 24 is locked by engaging the engaging protrusions 24a with engaging recesses (not shown) formed in an inner surface of a bus bar holder mounting part 46 of the housing 21.

The switch 22 is slid to the side of bus bar holder after the switch 22 is inserted into the port 39 for switch from the upper side of FIG. 6.

Also, the roof harness connector 38 is constructed so as to be detachably fitted into the roof harness connector connecting part 37 of the housing 21. A roof harness connector connecting port 49 is formed in this roof harness connector connecting part 37, and the roof harness connector 38 is inserted into this roof harness connector connecting port 49.

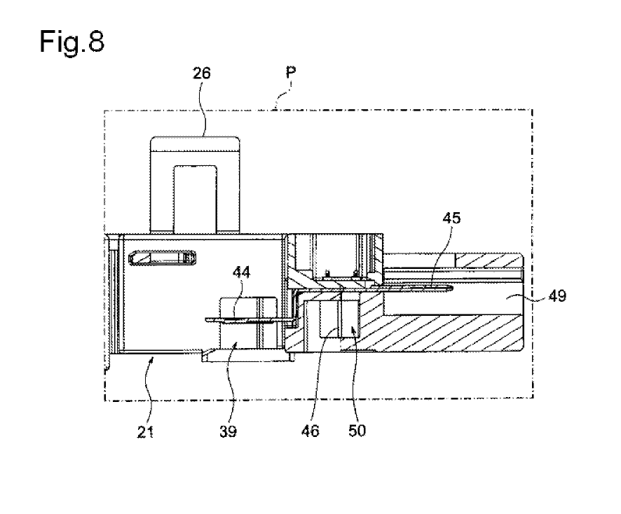

FIG. 7(A) to FIG. 8 show a state in which the bus bar holder 24 attached to the bus bar 23 is mounted in the housing 21 of the housing subassembly 20.

FIG. 7(A) is a plan view of the housing subassembly in a state of mounting the bus holder in which the bus bar is mounted in the housing shown in FIG. 4, and FIG. 7(B) is a sectional view taken on line A-A of the housing subassembly shown in FIG. 7(A), and FIG. 8 is an enlarged view of a place shown by P of FIG. 7(B).

In the drawings, in the housing 21, an electric wire holder port 50 into which an electric wire holder 52 is inserted is formed between the port 39 for switch and the roof harness connector connecting port 49.

Also, the bus bar holder 24 to which the bus bar 23 is attached is assembled to the housing 21.

When the bus bar holder 24 to which this bus bar 23 is attached is mounted in the housing 21, the terminals 44 for switch connection of the bus bar 23 connected to the switch 22 are arranged so as to be exposed to the port 39 for switch.

Also, the terminals 45 for roof harness connection of the bus bar 23 are arranged so as to be exposed to the connector port 49 for roof W/H connection.

Further, the crimp terminal parts 46 of the bus bar 23 for making connection to the lamp for interior illumination are arranged so as to be exposed to the inside of the electric wire holder port 50.

Then, by assembling the switch 22 to the housing 21 to which the bus bar holder 24 is attached, the terminals 44 for switch connection of the bus bar 23 are inserted into the terminal insertion holes 43 formed in the front wall 40c of the switch 22 mounted in the port 39 for switch, and the terminals 44 for switch connection are electrically connected to terminal parts of the switch 22.

Further, an electric wire holder of a splicer for supplying a power source to the LED used as the lamp for interior illumination mounted in the LED unit is mounted in the electric wire holder port 50 and thereby, an electric wire held in the electric wire holder is connected to the crimp terminal parts 46 of the bus bar 23 by crimping, and the power source is supplied to the lamp for interior illumination from the wire harness wired to the back of the roof of the inside of the vehicle room from a battery.

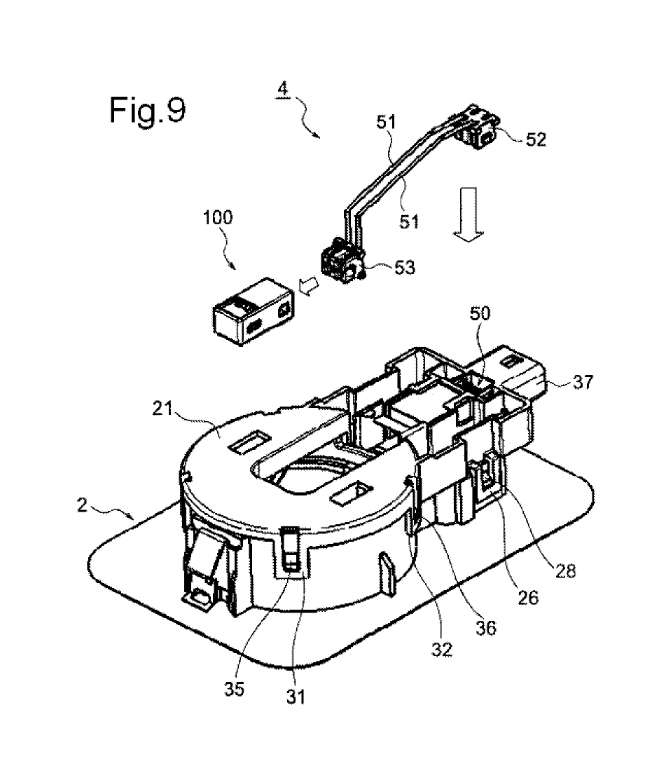

FIG. 9 shows an LED unit and the splicer 4 for connecting an LED unit subassembly 3 to an LED lamp mounted in the housing 21 of the interior illuminating apparatus 1 for vehicle.

In the drawing, the splicer 4 is means for connecting the LED unit subassembly 3 to the LED lamp, and includes two electric wires 51, an electric wire holder 52 attached to one end of the two electric wires 51, and an electric wire holder 53 attached to the other end of the two electric wires 51.

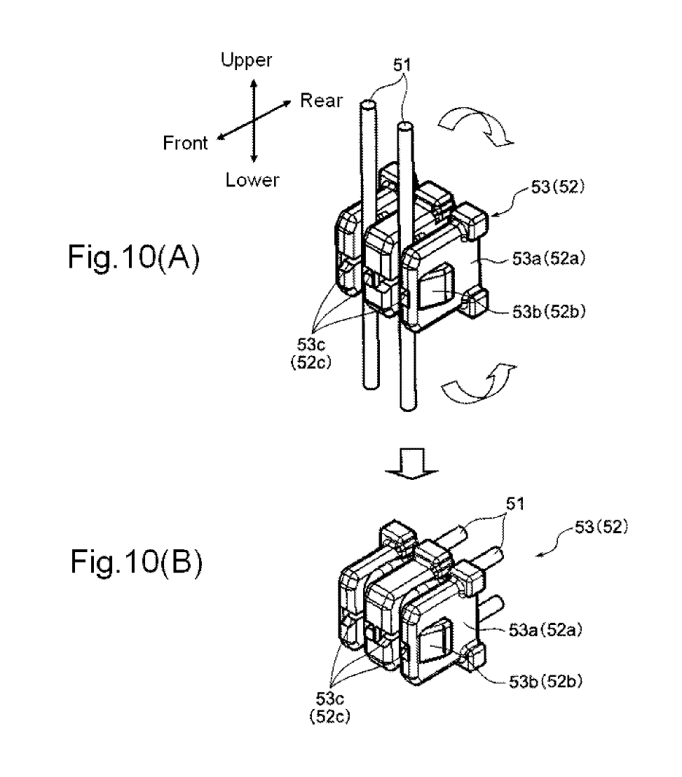

FIG. 10 shows the details of the electric wire holder 53 shown in FIG. 9.

In the drawing, the electric wire holders 52, 53 are received inside the electric wire holder port 50 in a state of holding bent portions of the electric wires 51 folded back and bent, and are means for electrically connecting the electric wires 51 to the crimp terminal parts 46 inside the electric wire holder port 50.

The two electric wires 51 electrically connected to a pair of crimp terminal parts 46 are held in the electric wire holders 52, 53. Also, the electric wire holders 52, 53 are configured to have bend holding parts 52a, 53a and lance parts 52b, 53b.

The bend holding parts 52a, 53a are means for holding the bent portions of each of the electric wires 51 folded back and bent. The bend holding parts 52a, 53a are formed so as to be inserted into the electric wire holder port 50 to a position in which the bent portions of each of the electric wires 51 are crimped to the crimp terminal parts 46. Also, the bend holding parts 52a, 53a are configured to have notches 52c, 53c formed so as to connect the crimp terminal parts 46 to the electric wires 51 in the front ends.

The lance parts 52b, 53b are means for fixing the electric wire holder 52 into the electric wire holder port 50 by engaging with engaging parts formed inside the electric wire holder port 50 as engaging parts.

By receiving this electric wire holder 52 inside the electric wire holder port 50 in a state of bending and holding each of the electric wires 51, that is, when the electric wire holder 53 is engaged with the LED unit subassembly 3 by the engaging parts, the folded portions of each of the electric wires 51 held by the electric wire holder 53 are electrically connected to a pair of crimp terminal parts 121.

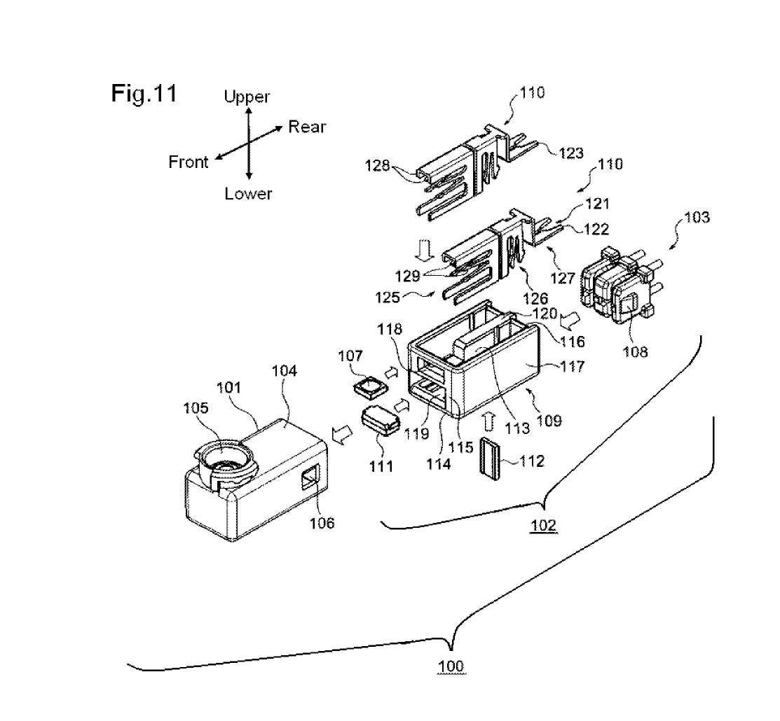

FIG. 11 shows the whole configuration of the LED unit incorporated into the interior illuminating apparatus for vehicle shown in FIG. 1.

In the drawing, the LED unit 100 is configured to have a unit housing 101, a connecting structure 102 of an electronic component, and an electric wire holder 103 as a connecting unit of the electronic component.

The unit housing 101 is means for receiving the connecting structure 102 of the electronic component and the electric wire holder 103. This unit housing 101 is a box-shaped cabinet in which an opening 104 used as an insertion hole for internally receiving the connecting structure 102 of the electronic component and the electric wire holding part 103 is formed. Also, the connecting structure 102 of the electronic component and the electric wire holding part 103 are arranged inside the unit housing 101 in order of the connecting structure 102 of the electronic component and the electric wire holding part 103 from the front. In addition, the unit housing 101 is configured to have an opening part 105 for illumination and an opening part 106 for engagement.

The opening part 105 for illumination is an opening formed in a wall forming an upper surface of the unit housing 101, and is means for outwardly emitting light emitted from an LED 107 received inside the unit housing 101. In addition, the opening part 105 for illumination may have a structure covered with a translucent member such as a lens.

The opening part 106 for engagement is an opening formed in a side wall in the vicinity of the opening 104 of the unit housing 101. This opening part 106 for engagement is means for engaging with a lance part 108 formed on the electric wire holding part 103 as an engaging part. That is, the opening part 106 for engagement engages with the lance part 108 and thereby, the connecting structure 102 of the electronic component and the electric wire holding part 103 can be fixed inside the unit housing 101.

The connecting structure 102 of the electronic component is configured to have an electronic component storage housing 109 and a pair of terminals 110 received inside the electronic component storage housing 109. This connecting structure 102 of the electronic component is means for electrically connecting the electronic components received inside the electronic component storage housing 109 by a pair of terminals 110 fixed inside the electronic component storage housing 109.

That is, the connecting structure 102 of the electronic component causes the LED 107, a zener diode 111 and a resistance plate 112 as the electronic components to be electrically connected and be received inside the electronic component storage housing 109.

The electronic component storage housing 109 is made of an insulating material, and is a box-shaped cabinet in which an opening part 113 is formed in an upper surface. This electronic component storage housing 109 is configured to have a rectangular bottom wall 114, and a front wall 115, a back wall 116 opposed to the front wall 115 and a pair of right and left opposed walls 117 as side walls respectively erected from four sides of the bottom wall 114. Also, the electronic component storage housing 109 is configured to have an LED element insertion hole 118, a zener diode insertion hole 119, a resistance plate insertion hole, a partition wall 120 and a terminal fixing part.

The LED element insertion hole 118 is an opening formed in the front wall 115 in order to insert the LED 107 into the electronic component storage housing 109.

The zener diode insertion hole 119 is an opening formed in the front wall 115 in order to insert the zener diode 111 into the electronic component storage housing 109.

The resistance plate insertion hole is an opening formed in the bottom wall 114 in order to insert the resistance plate 112 into the electronic component storage housing 109.

A pair of terminals 110 is two terminals with the same shape. This pair of terminals 110 is arranged inside the electronic component storage housing 109 in a state of juxtaposing positions of ends 122 in which crimp terminal parts 121 described below are formed and ends 123 opposed to the ends 122. Also, a pair of terminals 110 is received in the electronic component storage housing 109 so that each of the crimp terminal parts 121 is exposed to the outside of the electronic component storage housing 109 through the opening part 113 and is erected to an outer surface of the back wall 116 of the electronic component storage housing 109.

Each of this pair of terminals 110 is a terminal obtained by integrally molding a conductive plate-shaped member by press working. The terminal 110 is configured to have a first component connecting part 125 and a second component connecting part 126 downward bent and formed from both longitudinally extending sides of a rectangular top plate part 124, and an electric wire connecting part 127 formed by downward bending a back end of the top plate part 124 and further backward bending the back end as shown in FIG. 11. Also, the top plate part 124 is configured to have a pair of bent edge parts 128 in which both edges forming both longitudinally extending sides of the top plate part 124 are downward bent.

The LED element connecting part 125 is means for pinching and fixing the LED 107 by a pair of bent edge parts 128 of the top plate part 124 and a pair of first contact pieces 129. That is, by inserting the LED 107 between a pair of bent edge parts 129 and a pair of first contact pieces 129, the LED 107 is pinched and fixed using elasticity of a pair of first contact pieces 129 and the LED 107 is electrically connected to a pair of terminals 110.

In addition, this embodiment does not limit this invention.

This application is based upon and claims the benefit of priority of Japanese Patent Application No. 2011-107464 filed on May 12, 2011, the contents of which are incorporated herein by reference.

### INDUSTRIAL APPLICABILITY

According to the invention, the bus bar can easily be fixed to the housing. Also, according to the invention, even in the case of changing the position of the LED which is the light source, the interior illuminating apparatus can be provided with flexibility, and electrical connection between the LED and the roof harness can be formed at low cost.

### REFERENCE SIGNS LIST

1 . . . INTERIOR ILLUMINATING APPARATUS FOR VEHICLE
2 . . . LED LAMP SUBASSEMBLY
4 . . . SPLICER
21 . . . HOUSING
22 . . . SWITCH
23 . . . BUS BAR
24 . . . BUS BAR HOLDER
44 . . . TERMINAL FOR SWITCH CONNECTION
45 . . . TERMINAL FOR ROOF HARNESS CONNECTION
46 . . . CRIMP TERMINAL PART
39 . . . PORT FOR SWITCH
47 . . . ENGAGING PROTRUSION
49 . . . CONNECTOR PORT FOR ROOF W/H CONNECTION
50 . . . ELECTRIC WIRE HOLDER PORT
51 . . . ELECTRIC WIRE
52,53 . . . ELECTRIC WIRE HOLDER
100 . . . LED UNIT
107 . . . LED

1. An interior illuminating apparatus for vehicle in which an LED unit into which an LED is incorporated is mounted in a housing and a bus bar holder to which a bus bar for electrically connecting the LED to a roof harness is fixed is assembled to the housing and the LED is turned on and the inside of a vehicle room is illuminated,
wherein the bus bar includes a terminal for switch connection which is electrically connected to a switch and is formed on one end side of the bus bar, a terminal for roof harness connection which is electrically connected to the roof harness wired to a roof of the inside of the vehicle room and receives supply of a power source, and a crimp terminal part for connecting an electric wire by crimping in the middle between the terminal for switch connection and the terminal for roof harness connection, and in the case of storing the bus bar in the housing, the terminal for switch connection of the bus bar is arranged so as to be exposed to a port for switch of the housing, and the terminal for roof harness connection of the bus bar is arranged so as to be exposed to a connector port for roof W/H connection of the housing, and the crimp terminal part of the bus bar is arranged so as to be exposed to the inside of an electric wire holder port of the housing, and an engaging protrusion formed on the bus bar holder is engaged and fixed to an engaging recess formed in the housing.

2. The interior illuminating apparatus for vehicle as claimed in claim 1, wherein electrical connection between the LED and a roof harness made by assembling the bus bar holder to which the bus bar is fixed to the housing is made so that using a splicer constructed of an electric wire and electric wire holders attached to both ends of the electric wire, one of the electric wire holders is electrically connected to the LED unit and also the other electric wire holder is inserted into the electric wire holder port of the housing and crimp connection is made by a crimp terminal part of the bus bar exposed to the inside of the electric wire holder port.
